(19) United States
(12) Patent Application Publication
(10) Pub. No.: US 2007/0113107 A1
(43) Pub. Date: May 17, 2007

(54) Control device

(75) Inventor: Shigeyoshi Ohara, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/373,158

(22) Filed: Mar. 13, 2006

(30) Foreign Application Priority Data
Nov. 16, 2005 (JP) 2005-331906

(51) Int. Cl. G06F 1/00

(52) U.S. Cl. 713/300

(57) ABSTRACT

A control device includes a control unit having operating modes having different heating values, and a fan unit including at least one fan for cooling the control unit in which the number of rotations varies depending on a voltage. The control unit includes a voltage supplying section for supplying different voltages corresponding to the operating modes. The fan unit includes a rotation control unit for rotating the fan with the highest voltage among the supplied different voltages.

### BACKGROUND OF THE INVENTION

1. Field of the Invention

The present invention relates to a control device including a cooling fan unit.

2. Description of the Related Art

In recent years, as various types of data have become digitized and handled on computers, the importance of storage servers that can efficiently store large amounts of data, separately from the computers, has been increasing. The storage servers have a feature in that, by employing RAID (redundant array of independent disks) technology, their reliability becomes more enhanced than simple disk drives. In addition, in general, the storage servers include built-in caches. This makes it possible to shorten a time to access data.

In the RAID technology, reliability is enhanced by techniques such as RAID-1 in which the same data is stored on a plurality of disks, and RAID-5 in which parity information is stored on disks in distributed form.

A storage server includes a control device and a disk drive.

The control device includes a main control unit, a control-and-monitoring unit, a power supply unit, a fan unit, and a breaker.

The main control unit includes a central processing unit (CPU), a memory controller, a host adapter, a cache memory, and a disk adapter. In order to realize various functions and to require having high performance, the main control unit consumes a large amount of power of approximately several hundred watts, and generates a very large heating value.

The control-and-monitoring unit has a function of monitoring power, temperature, etc., and includes a microcomputer, a memory, and a monitoring circuit that have minimum performance. Accordingly, the control-and-monitoring unit only needs power of approximately several watts, thus generating a small heating value.

The power supply unit uses standby power to drive the control-and-monitoring unit, and uses main power to drive the main control unit.

During the use of the standby power, the fan unit is not driven. During the use of the main power, the fan unit cools the main control unit and the control-and-monitoring unit.

The power supply unit and the fan unit may be used in common to a plurality of control devices without being provided in units of control devices.

Power supply control by the control device is described below.

At first, by turning on the breaker, the control-and-monitoring unit is started to operate. After that, by pressing a power supply switch of the control-and-monitoring unit, the control-and-monitoring unit supplies power to the main control unit.

Cooling of the control-and-monitoring unit and the main control unit by the fan unit is performed after the main control unit is activated, and is not performed in a standby mode in which only the control-and-monitoring unit is driven.

In addition, with increased demand for an increase in device size, and device reliability and usability, the control-and-monitoring unit also tends to be highly functional and of high performance. For example, a large storage server may include several hundred or more disk drives. Accordingly, the load on the control-and-monitoring unit for monitoring the states of the disk drives increases.

As described above, as the control-and-monitoring unit becomes highly functional and comes to have high performance, power consumption accordingly increases, so that generated heat also increases. Therefore, during the standby mode in which only the control-and-monitoring unit is driven, relying on natural cooling, as it has been performed, is difficult.

### SUMMARY OF THE INVENTION

According to an aspect of the present invention, a control device includes a control unit having a plurality of operating modes having different heating values, and a fan unit including at least one fan for cooling the control unit in which the number of rotations varies depending on a voltage. The control unit includes a voltage supplying section for supplying the fan unit with different voltages corresponding to the operating modes, and the fan unit includes a rotation control section for rotating the at least one fan with the highest voltage among the supplied different voltages.

In each operating mode of the control device, fan rotation can be performed at the optimal number of rotations for cooling. Thus, heating by the control device can optimally be suppressed.

### BRIEF DESCRIPTION OF THE DRAWINGS

FIG. 1 is a block diagram of a control device according to an embodiment of the present invention;

FIG. 2 is an illustration of a power-on/off sequence in the embodiment; and

FIG. 3 is a circuit block diagram of a fan unit board in the embodiment.

### DESCRIPTION OF THE PREFERRED EMBODIMENTS

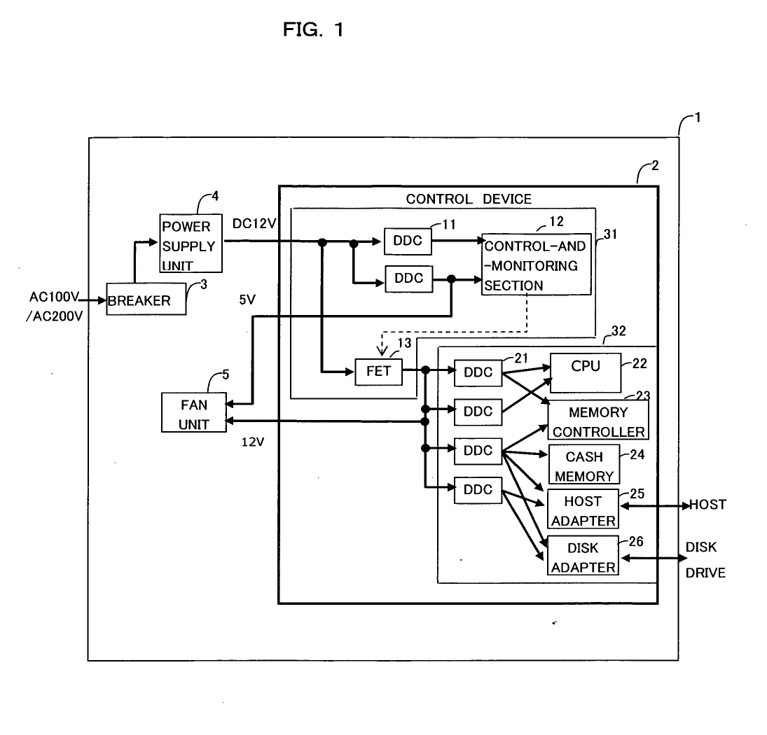

FIG. 1 is a block diagram of a control device 1 according to an embodiment of the present invention.

FIG. 1 shows the configuration of the control device 1 in terms of a power system.

The control device 1 includes a control unit 2, a braker 3, a power supply unit 4, and a fan unit 5.

The control unit 2 includes a standby control section 31 and a main control section 32.

The breaker 3 determines whether to input external power of AC 100 or 200 volts to the power supply unit 4. The power supply unit 4 generates 12-volt DC power from the external power of AC 100 or 200 volts. The generated 12-volt DC power is supplied to DC-DC converters (hereinafter referred to as “DDCs” ) 11 and FET 13 of the standby control section 31.

The fan unit 5 cools the entirety of the control unit 2.

The standby control section 31 includes the DDCs 11, a control-and-monitoring section 12, and the FET 13. One DDC 11 converts the 12-volt power supplied from the power supply unit 4 to 5-volt power for the fan unit 5, and the other DDC 11 converts the 12-volt power to a predetermined voltage that is supplied as power to the control-and-monitoring section 12.

The control-and-monitoring section 12 controls initial setting of a CPU 22, a memory controller 23, a host adapter 25, and a disk adapter 26, monitoring of power and temperature, etc. The control-and-monitoring section 12 also includes power-on and power-off switches.

In response to a power-on or power-off instruction from the control-and-monitoring section 12, the FET 13 controls starting or stopping supply of the 12-volt power supplied by the power supply unit 4 to the fan unit 5 and the main control section 32.

The main control section 32 includes DDCs 21, the CPU 22, a memory controller 23, a cache memory 24, a host adapter 25, and a disk adapter 26.

After converting the 12-volt power to the voltages required by corresponding units, such as the CPU 22, and the DDCs 21 supply the required voltages to the corresponding units.

The CPU 22 realizes basic functions of the control device 1, such as control of the host adapter 25 and the disk adapter 26, RAID control, and cache control.

The memory controller 23 mutually connects the CPU 22, the host adapter 25, the disk adapter 26, and the cache memory 24, and realizes exchanging data and messages among them.

The cache memory 24 temporarily stores data that is transmitted to and received from a host or a disk drive.

The host adapter 25 controls data transmission and reception to/from the host.

The disk adapter 26 controls data transmission and reception to/from the disk drive.

Next, a power supply operation of the control device 1 is described below.

AC power input to the control device 1 is converted into DC power by the power supply unit 4. In general, a voltage of 100 or 200 volts is used as the AC power, and a voltage of 12 volts is used as the DC power.

The DC power supplied from the power supply unit 4 is divided on a printed-circuit board forming the control unit 2 into three, that is, power supplied to the control-and-monitoring section 12, power supplied to the fan unit 5, and power supplied to the main control section 32.

Specifically, the 5-volt power obtained by one DDC 11 is supplied to the fan unit 5.

Also, the power required by the control-and-monitoring section 12 is converted and supplied by the DDCs 11.

In addition, supply of the 12-volt power for the fan unit 5 and the main control section 32 is started and stopped by the FET 13. Control of the FET 13 is handled by the control-and-monitoring section 12.

The 12-volt power supplied to the main control section 32 is converted by the DDCs 21 to the voltages required by various electronic components on the printed-circuit board.

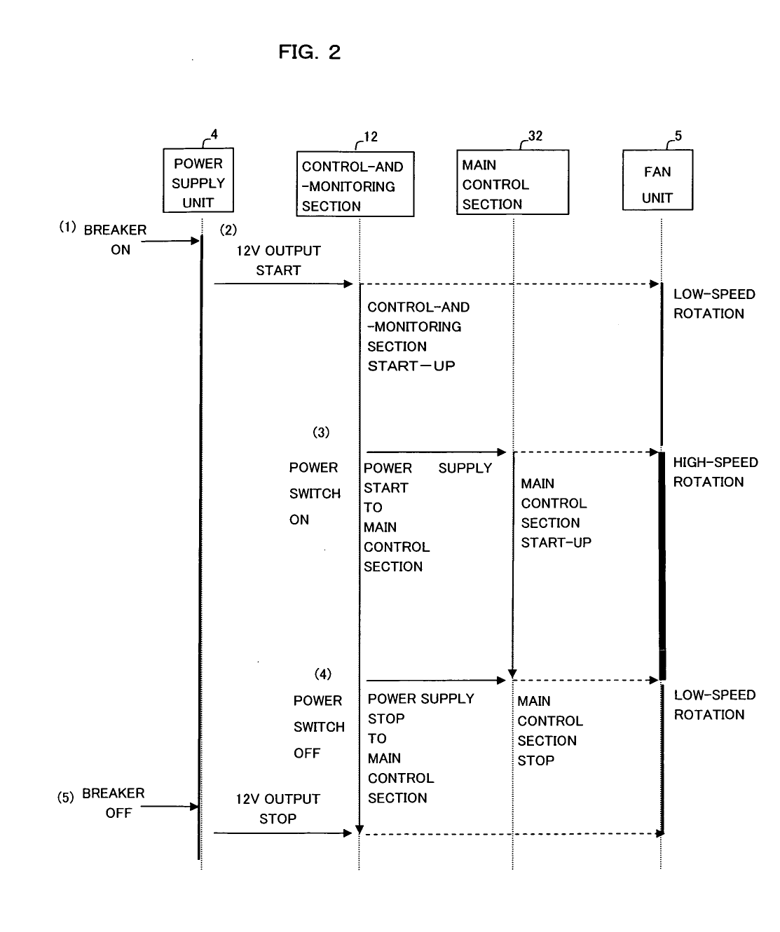

FIG. 2 shows the following power-on/power-off sequence in the embodiment.
(1) By plugging the control device 1 in and turning on the breaker 3, the AC power is supplied to the power supply unit 4.
(2) The power supply unit 4 outputs the 12-volt DC power after converting the AC power, and the 12-volt DC power is converted by one DDC 11 to a 5-volt voltage or the like before being supplied to the control-and-monitoring section 12. Thus, the control-and-monitoring section 12 is activated and started to operate. In addition, since the 5-volt power output from the other DDC 11 is supplied also to the fan unit 5, fan rotation of the fan unit 5 starts at low speed with a low voltage. At this time, the control-and-monitoring section 12 closes a switch formed by the FET 13, so that the main control section 32 is supplied with no power. Control unit 2 is in a stand-by mode.
(3) In response to pressing of the power-on switch, the switch formed by the FET 13 is opened by the control-and-monitoring section 12 to start supply of power to the main control section 32 and the fan unit 5. Then, the main control section 32 is activated and started to operate. In addition, by supplying the 12-volt power, the fan unit 5 is started to have fan rotation at high speed. Control unit 2 is in a normal mode.
(4) In response to pressing of the power-off switch, the control-and-monitoring section 12 closes the switch formed by the FET 13, so that the supply of the power to the main control section 32 and the fan unit 5 is stopped. Then, the main control section 32 is stopped to operate. The fan unit 5 changes to have fan rotation at low speed since fan unit 5 continues to be supplied with the 5-volt power. Control unit 2 is in the stand-by mode.
(5) By turning off the breaker 3, the input of the AC power to the power supply unit 4 is stopped, so that the output of the 12-volt DC power is also stopped, the control-and-monitoring section 12 is also stopped to operate, and the fan rotation is stopped.

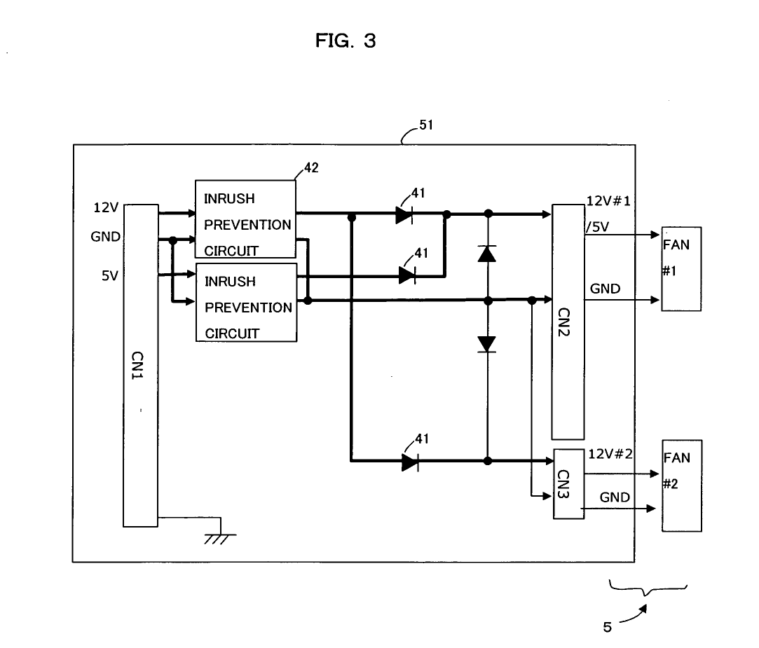

FIG. 3 is a circuit block diagram of a fan unit board 51 in the embodiment.

The fan unit 5 includes a plurality of fans and the fan unit board 51.

Two voltages of 12 volts and 5 volts are applied to the fan unit 5. Both voltages are supplied from a connector CN1 of the fan unit board 51 in the fan unit 5 to the anodes of two diodes 41 through inrush prevention circuits 42. The cathodes of the diodes 41 are wired in an OR manner. The output of wired OR connection is supplied from a connector CN2 of the fan unit board 51 to FAN#1.

As a result, although the voltages of 12 volts and 5 volts are supplied to the fan unit 5 while the main control section 32 is operating, the voltage of 12 volts is output because of the wired OR connection, and FAN#1 rotates at high speed. Since only the voltage of 12 volts is supplied from a connector CN3 of the fan unit board 51 to FAN#2, FAN#2 rotates at high speed.

In addition, in a standby mode in which only the control-and-monitoring section 12 is driven, only the voltage of 5 volts is supplied to the fan unit 5. Thus, the output of the wired OR connection is 5 volts. This causes FAN#1 to rotate at low speed. The wired OR connection is used only for FAN#l as a single fan. Accordingly, FAN#2 as another fan does not rotate since it is not supplied with the voltage of 12 volts.

As a result, in the standby mode, among the plurality of fans, only FAN#1 is supplied with power, and the other fans are not supplied with power.

This enables the fan unit 5 to be driven with minimum noise and power consumption that are necessary for cooling the control-and-monitoring section 12.

What is claimed is:

1. A control device comprising:
(a) a control unit having a plurality of operating modes with different heating values; said control unit including:
a voltage supplying section for supplying a fan unit with different voltages corresponding to the operating modes; and
(b) a fan unit; said fan unit including:
(1) at least one fan for changing rotational speed to cool the control unit in proportional to voltages, and
(2) a rotation control section for rotating said at least one fan with the highest voltage among the supplied different voltages.

2. The control device according to claim 1, wherein:
when the control unit is in a standby mode among the operating modes, the voltage supplying section supplies a first voltage among the different voltages, and, when the control unit is in a normal mode among the operating modes, the voltage supplying section supplies the first voltage and a second voltage which is higher than the first voltage; and
in the standby mode, the rotation control section controls said at least one fan to rotate at low speed with the first voltage, and, in the normal mode, the rotation control section controls said at least one fan to rotate at high speed with the second voltage.

3. The control device according to claim 2, wherein, in the standby mode, the fan unit rotates only at least one predetermined fan among said at least one fan, and, in the normal mode, the fan unit rotates all said at least one fan.
